(19) United States
(12) Patent Application Publication
(10) Pub. No.: US 2025/0220393 A1
(43) Pub. Date: Jul. 3, 2025

(54) METHOD AND ELECTRONIC DEVICE FOR DISPLAYING POSITION OF FIRST DEVICE ON SECOND DEVICE

(71) Applicant: SAMSUNG ELECTRONICS CO., LTD., Suwon-si (KR)

(72) Inventors: Gurmanjeet Singh SIDHU, Sri Muktsar Sahib (IN); Vishal Sharma, Delhi (IN)

(73) Assignee: SAMSUNG ELECTRONICS CO., LTD., Suwon-si (KR)

(21) Appl. No.: 19/082,776

(22) Filed: Mar. 18, 2025

Related U.S. Application Data
(63) Continuation of application No. PCT/KR2023/010863, filed on Jul. 26, 2023.

(30) Foreign Application Priority Data
Oct. 18, 2022 (IN) 202211059615

(51) Int. Cl. H04W 4/029; H04W 4/02

(52) U.S. Cl. CPC H04W 4/029; H04W 4/026

(57) ABSTRACT

Provided is a method and device for displaying a position of a first device on a second device. The method includes: detecting, by a device using a UWB chip, position coordinates in a first coordinate system of the first device with respect to a position of the device; converting, by the device, the position coordinates of the first device in the first coordinate system into position coordinates of the first device in a global coordinate system; converting, by the device, the position coordinates of the first device in the global coordinate system into position coordinates of the first device in a user coordinate system; transmitting the converted position coordinates of the first device in the user coordinate system to the second device; and displaying the position of the first device on the second device based on the converted position coordinates of the first device in the user coordinate system.

### CROSS-REFERENCE TO RELATED APPLICATIONS

This application is a by-pass continuation of International Application No. PCT/KR2023/010863, filed on Jul. 26, 2023, which is based on and claims priority to Indian Patent Application number 202211059615, filed on Oct. 18, 2022, the disclosures of which are incorporated by reference herein in their entireties.

### BACKGROUND

### 1. Field

The present disclosure relates to an electronic device, and more specifically, to a method and an electronic device for displaying a position of a first device on a second device.

### 2. Description of Related Art

Ultra-wideband (UWB) is a short-range radio technology which may be used for indoor positioning of electronic devices. Bluetooth Low Energy and Wi-Fi use measurement of signal strengths (such as Receive Signal Strength Indicator (RSSI)) to determine the position of electronic devices. In contrast, the UWB uses the transit time method (Time of Flight (ToF)) to determine the position of electronic devices. The transit time method is a technique that measures the time it takes for a signal to travel from one point to another. In the case of UWB, the signal is a UWB radio wave. UWB tags are electronic devices that are attached to objects that need to be tracked. To find a UWB tag, two-way ranging (TWR) is used to determine the Time of Flight of the UWB RF signal between two electronic devices. TWR in combination with phase difference of arrival (PDoA), which provides measurement of angle of arrival, is used to localize the position of the UWB tag. TWR measures the running time of light between an object (e.g., UWB Tags) and several receivers (e.g., UWB locator nodes). For the exact localization of an object, at least three receivers are necessary (i.e., trilateration). Also, there must be direct line-of-sight between receiver and transmitter.

In existing techniques, smart electronic devices such as smart watches may support UWB based features/applications only with an inbuilt UWB chip. Since UWB localization accuracy depends on the distance and angle estimation between the UWB tag/object and Locator UWB node based on the time of arrival (TOA) of UWB pulses. Therefore, if the UWB chip is not inbuilt or not present in a locator node (such as a smartwatch), the distance and angle are not accurately found. For example, if a UWB chip is not present in the UWB node, such as a smart watch, then the position of the UWB tag may not be accurately found. By contrast, if a UWB chip is included in a UWB node, such as a smart watch, then it results in increased cost and power consumption at the UWB node.

### SUMMARY

According to an embodiment of the disclosure, a method for displaying a position of a first device on a second device includes: detecting, by an electronic device using an ultra-wide band (UWB) chip, position coordinates of the first device with respect to a position of the electronic device, wherein the position coordinates of the first device correspond to position coordinates in a first coordinate system; converting, by the electronic device, the position coordinates of the first device in the first coordinate system into position coordinates of the first device in a global coordinate system; converting, by the electronic device, the position coordinates of the first device in the global coordinate system into position coordinates of the first device in a user coordinate system; transmitting, by the electronic device, the converted position coordinates of the first device in the user coordinate system to the second device; and displaying the position of the first device on the second device based on the converted position coordinates of the first device in the user coordinate system.

The displaying the position of the first device on the second device may include: re-converting, by the second device, the converted position coordinates of the first device in the user coordinate system into position coordinates of the first device in a second coordinate system; obtaining the position of the first device based on the position coordinates of the first device in the second coordinate system; and controlling a display screen of the second device to display the obtained position of the first device.

The position of the first device may be defined with respect to a UWB sensor plane of the electronic device in the first coordinate system, a user of the electronic device may be defined as an origin point of the position coordinates of the first device in the user coordinate system, and the electronic device may be defined as an origin point of the position coordinates of the first device in the global coordinate system.

The converting the position coordinates of the first device in the global coordinate system into the position coordinates of the first device in the user coordinate system may include: determining a height and a gait of the user using a position sensor of the electronic device; determining the position and a direction of the electronic device based on the height and the gait of the user; and converting the position coordinates of the first device in the global coordinate system into the position coordinates of the first device in the user coordinate system based on the height and the gait of the user.

The first device may include a UWB tag.

The second device may not include a UWB chip.

The converting the position coordinates of the first device in the first coordinate system into the position coordinates of the first device in the global coordinate system may include converting the position coordinates of the first device via a rotation matrix obtained using the position sensor.

According to an aspect of the disclosure, an electronic device includes: a transceiver; an ultra-wide band (UWB) chip configured to detect UWB devices within a distance of the UWB chip; memory storing one or more instructions; and at least one processor configured to execute the one or more instructions, wherein the one or more instructions, when executed by the at least one processor, cause the electronic device to: detect, using the UWB chip, position coordinates of a first device with respect to a position of the electronic device, wherein the position coordinates of the first device correspond to position coordinates in a first coordinate system, convert the position coordinates of the first device into position coordinates of the first device in a global coordinate system, convert the position coordinates of the first device in the global coordinate system into position coordinates of the first device in a user coordinate system, transmit, to a second device through the transceiver, the converted position coordinates of the first device in the user coordinate system, and control the second device to display a position of the first device based on the converted position coordinates of the first device in the user coordinate system.

The one or more instructions, when executed by the at least one processor, may cause the electronic device to: control the second device to re-convert the converted position coordinates of the first device in the user coordinate system into position coordinates of the first device in a second coordinate system, to obtain the position of the first device based on the position coordinates of the first device in the second coordinate system, and control the second device to display, on a display screen of the second device, the obtained position of the first device.

The position of the first device may be defined with respect to a UWB sensor plane of the electronic device in the first coordinate system, a user of the electronic device may be defined as an origin point of the position coordinates of the first device in the user coordinate system, and the electronic device may be defined as an origin point of the position coordinates of the first device in the global coordinate system.

The electronic device may further include: a position sensor, and the one or more instructions, when executed by the at least one processor, may cause the electronic device to convert the position coordinates of the first device in the global coordinate system into the position coordinates of the first device in the user coordinate system by: determining a height and a gait of the user, using the position sensor, determining the position and a direction of the electronic device based on the height and the gait of the user, and converting the position coordinates of the first device in the global coordinate system into the position coordinates of the first device in the user coordinate system based on the height and the gait of the user.

The one or more instructions, when executed by the at least one processor, may cause the electronic device to: convert the position coordinates of the first device in the first coordinate system into the position coordinates of the first device in the global coordinate system via a rotation matrix obtained using the position sensor.

According to an aspect of the disclosure, a non-transitory computer readable medium has instructions stored therein, which when executed by at least one processor cause the at least one processor to execute a method for displaying a position of a first device on a second device, the method including: detecting, by an electronic device using an ultra-wide band (UWB) tag, position coordinates of the first device with respect to a position of the electronic device, wherein the position coordinates of the first device correspond to position coordinates in a first coordinate system; converting, by the electronic device, the position coordinates of the first device in the first coordinate system into position coordinates of the first device in a global coordinate system; converting, by the electronic device, the position coordinates of the first device in the global coordinate system into position coordinates of the first device in a user coordinate system; transmitting, by the electronic device, the converted position coordinates of the first device in the user coordinate system to the second device; and displaying the position of the first device on the second device based on the converted position coordinates of the first device in the user coordinate system.

With regard to the method executed by the at least one processor based on the instructions stored in the non-transitory computer readable medium, the displaying the position of the first device on the second device may include: re-converting, by the second device, the converted position coordinates of the first device in the user coordinate system into position coordinates of the first device in a second coordinate system; obtaining the position of the first device based on the position coordinates of the first device in the second coordinate system; and controlling a display screen of the second device to display the obtained position of the first device.

With regard to the method executed by the at least one processor based on the instructions stored in the non-transitory computer readable medium, the position of the first device may be defined with respect to a UWB sensor plane of the electronic device in the first coordinate system, a user of the electronic device may be defined as an origin point of the position coordinates of the first device in the user coordinate system, and the electronic device may be defined as an origin point of the position coordinates of the first device in the global coordinate system.

With regard to the method executed by the at least one processor based on the instructions stored in the non-transitory computer readable medium, the converting the position coordinates of the first device in the global coordinate system into the position coordinates of the first device in the user coordinate system may include: determining a height and a gait of the user using a position sensor of the electronic device; determining the position and a direction of the electronic device based on the height and the gait of the user; and converting the position coordinates of the first device in the global coordinate system into the position coordinates of the first device in the user coordinate system based on the height and the gait of the user.

With regard to the method executed by the at least one processor based on the instructions stored in the non-transitory computer readable medium, the first device may include a UWB tag.

With regard to the method executed by the at least one processor based on the instructions stored in the non-transitory computer readable medium, the second device may not include a UWB chip.

With regard to the method executed by the at least one processor based on the instructions stored in the non-transitory computer readable medium, the converting the position coordinates of the first device in the first coordinate system into the position coordinates of the first device in the global coordinate system may include converting the position coordinates of the first device via a rotation matrix obtained using the position sensor.

According to an aspect of the disclosure, a system for displaying a location of a first device on a second device includes: the second device, including: a second transceiver; second memory storing one or more second instructions; and at least one second processor configured to execute the one or more second instructions; and an electronic device including: a first transceiver; first memory storing one or more first instructions; and at least one first processor configured to execute the one or more first instructions, wherein the one or more first instructions, when executed by the at least one first processor, cause the electronic device to: detect position coordinates of the first device with respect to a position of the electronic device, wherein the position coordinates of the first device correspond to position coordinates in a first coordinate system, convert the position coordinates of the first device into position coordinates of the first device in a global coordinate system, convert the position coordinates of the first device in the global coordinate system into position coordinates of the first device in a user coordinate system, and transmit, to the second device through the first transceiver, the converted position coordinates of the first device in the user coordinate system, and wherein the one or more second instructions, when executed by the at least one second processor, cause the second device to: display, on the display, a position of the first device based on the converted position coordinates of the first device transmitted by the electronic device.

To further clarify the features of the present disclosure, a more particular description of the present disclosure will be rendered by reference to embodiments thereof, which is illustrated in the appended drawing. It should be appreciated that these drawings depict only typical embodiments of the present disclosure and are therefore not to be considered limiting its scope. The present disclosure will be described and explained with additional specificity and detail with the accompanying drawings.

### BRIEF DESCRIPTION OF THE DRAWINGS

The above and other aspects and features of certain embodiments of the present disclosure will be more apparent from the following description taken in conjunction with the accompanying drawings, in which:

FIG. 1 illustrates a method of determining a position of a tag;

FIG. 2 illustrates a flow diagram depicting a method for displaying a position of a first device on a second device, in accordance with one or more embodiments of the present disclosure;

FIG. 3 illustrates a block diagram of an electronic device for displaying a position of a first device on a second device, in accordance with an embodiment of the present disclosure;

FIG. 4 illustrates an environment for displaying a position of a first device on a second device, in accordance with an embodiment of the present disclosure;

FIG. 5 illustrates determination of position coordinates of a first device in a first coordinate system, in accordance with an embodiment of the present disclosure;

FIG. 6 illustrates conversion of position coordinates of a first device in a first coordinate system to a global coordinate system, in accordance with an embodiment of the present disclosure;

FIG. 7 illustrates conversion of position coordinates of a first device in a global coordinate system to a user coordinate system, in accordance with an embodiment of the present disclosure;

FIG. 8 illustrates a flow diagram depicting a method for displaying a position of a first device on a second device, in accordance with an embodiment of the present disclosure;

FIG. 9 illustrates a block diagram of a second device for displaying a position of a first device on a second device, in accordance with an embodiment of the present disclosure;

FIG. 10 illustrates conversion of position coordinates of a first device in a user coordinate system into an intermediary coordinate system, in accordance with an embodiment of the present disclosure; and

FIG. 11 illustrates conversion of position coordinates of a first device in an intermediary coordinate system into a second coordinate system, in accordance with an embodiment of the present disclosure.

The drawings are illustrated for simplicity and may not have been necessarily drawn to scale. For example, the flow charts illustrate the method in terms of the most prominent steps involved to help to improve understanding of aspects of the present disclosure. Furthermore, in terms of the construction of the electronic device, one or more components of the electronic device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DISCLOSURE

For the purpose of promoting an understanding of the principles of the present disclosure, reference will now be made to the embodiment illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof are intended to cover a non-exclusive inclusion, such that a process or method that comprises a list of steps does not include only those steps but may include other steps not expressly listed or inherent to such process or method. Similarly, one or more electronic devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

In this disclosure, the terms “transmit,” “receive,” “communicate,” as well as derivatives thereof encompass both direct and indirect communication. The terms “include” and “comprise,” as well as derivatives thereof mean inclusion without limitation. The term “or” is inclusive meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below may be implemented or supported by one or more computer programs, each of which is formed from a computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A computer readable medium excludes wired, wireless, optical, or other communication links that transport transitory electrical or other signals. A computer readable medium includes media where data may be permanently stored and media where data may be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it may be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device may perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In an embodiment, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to an embodiment of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

The techniques of the present disclosure have been described in respect of a first device, second device and third device. The first, second, and third devices may include but are not limited to any electronic device such as mobile device, smart watch, smart TV, laptop etc. The first device includes an Ultra-WideBand (UWB) tag (or a first UWB tag), whereas the electronic device includes a UWB tag (or a second UWB tag). The electronic device may be referred to as a third device. The second device does not include any UWB tag. According to an embodiment of the present disclosure, position of the first device is determined by the electronic device using the UWB tag and is displayed on the second device without any UWB tag. For example, the first device may be a UWB tag, the second device may be a smart watch, and the electronic device may be a mobile device (such as a mobile phone or a smart phone). In the case that the second device may be a part of the smart watch, the second device may be connected to the smart watch. In the case that the electronic device may be a part of the mobile device, the electronic device may be connected to the mobile device.

This disclosure relates to a method and an electronic device for displaying a position of the first device including the UWB tag on the second device that does not include any UWB tag.

This disclosure relates to a method and an electronic device for displaying a position of the first device including the UWB tag on a display screen of the second device. Therefore, this disclosure may determine an accurate position of the first device including the UWB tag, and accordingly, may display the accurate position on an interface of the second devices, such as a smart watch, without any UWB tag. Also, by displaying the position of the tracked UWB tag in a node (for example, the second device or a smart watch) without the UWB tag, this disclosure may avoid the increase in cost and power consumption due to the presence of the UWB tag. In this disclosure, the UWB tag may be referred to as a UWB chip.

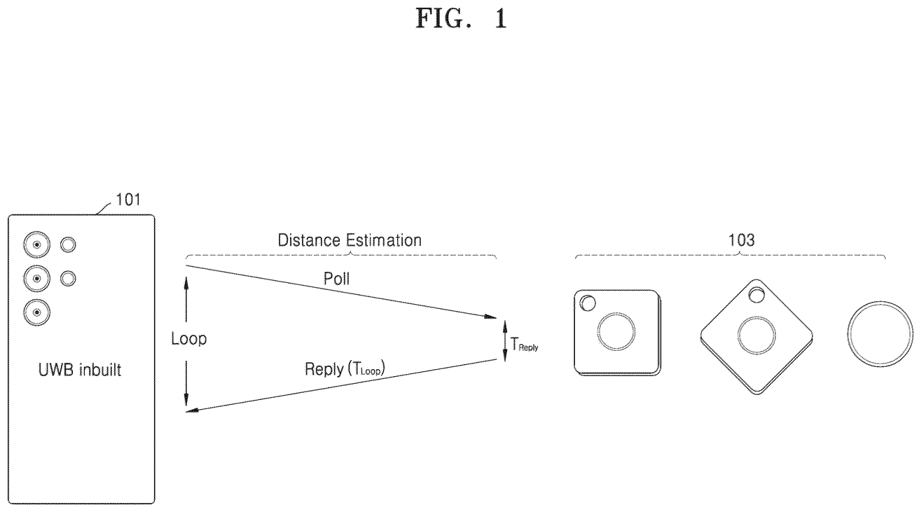

FIG. 1 illustrates an example of determination of a position of an Ultra-wideband (UWB) tag 103. As shown in FIG. 1, the mobile device 101 has an inbuilt UWB chip and is configured to determine a position of a responder, i.e., a UWB tag 103. The UWB tag 103 and the UWB chip both use UWB technology. The UWB tag 103 is an electronic device that may store and transmit data. The UWB tag 103 is detected by UWB receivers. The UWB tag 103 may be used to track the location of an object or for access control. The UWB chip is device that may receive an process data. The UWB chip may be detected by a UWB receiver and a UWB transceiver. The UWB chip may be used to perceive its surroundings or manipulate objects.

To find the UWB tag 103, two-way ranging (TWR) is used in determining the Time of Flight (ToF) of a UWB RF signal between the mobile device 101 and the UWB tag 103. The TWR is a technique that measures the time (or ToF) it takes for the UWB RF signal to travel from one point (for example, the mobile device 101) to another point (for example, the UWB tag 103) and calculate a distance between the two points (the mobile device 101 and the UWB tag 103).

The ToF may be determined according to the following equation 1:

$$ToF = \frac{{T}_{Loop} - {T}_{Replay}}{2} \qquad ( 1 )$$

As used in Equation 1, ToF is a time of flight, T_{Loop} is a time difference between a signal initiated (or transferred) from the mobile device 101 and a response received at the mobile device 101 (or initiator's end), and T_{Reply} is a time taken by the responder (the UWB tag 103 shown in FIG. 1) to send a reply for the signal.

However, in the case of FIG. 1, the UWB chip should be present in the UWB tag 103 as well as in the mobile device 101, which is a UWB node. If the UWB chip is not present in the UWB tag 103, then the position of the UWB tag 103 may not be accurately determined.

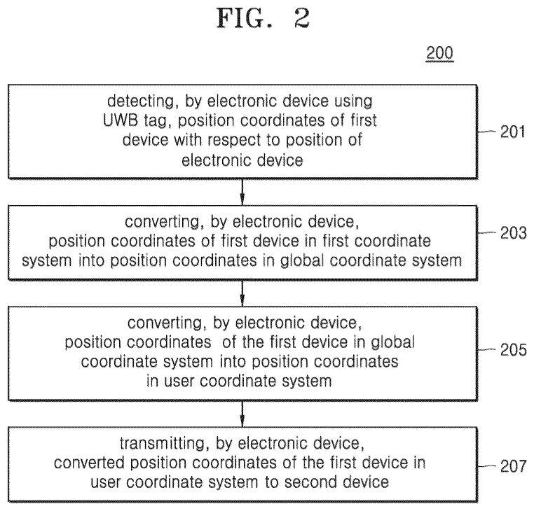

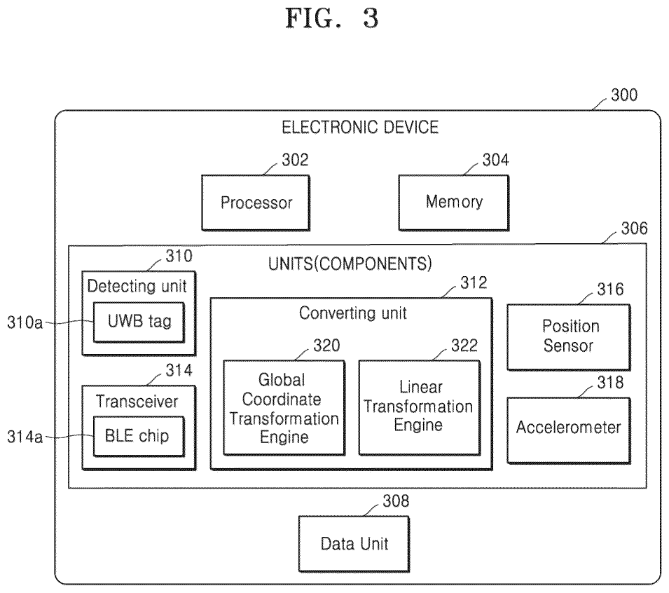

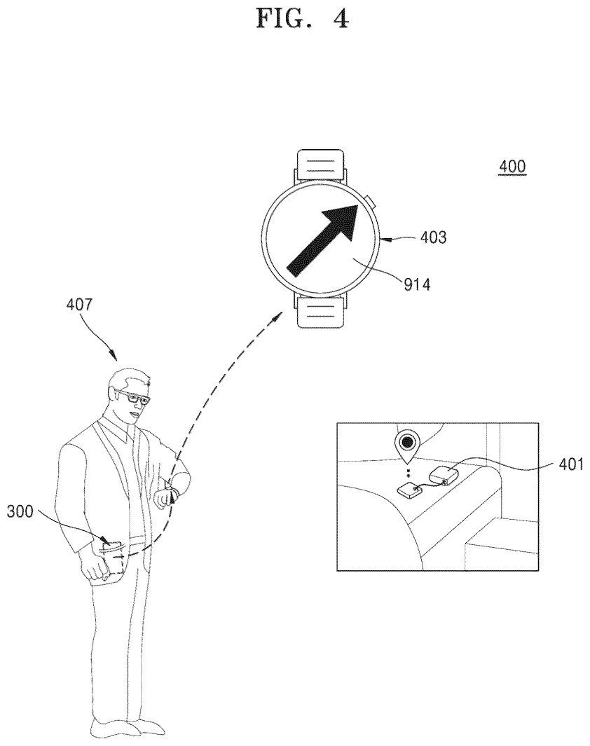

FIG. 2 illustrates a flow diagram depicting a method for displaying a position of a first device on a second device, in accordance with an embodiment of the present disclosure. FIG. 3 illustrates a block diagram of an electronic device for displaying a position of a first device on a second device, in accordance with an embodiment of the present disclosure. FIG. 4 illustrates an environment for displaying a position of a first device on a second device, in accordance with an embodiment of the present disclosure. For the sake of brevity, the descriptions of FIGS. 2-4 are explained in conjunction with each other.

Referring to FIG. 3, the electronic device 300 may include, but is not limited to, a processor 302, memory 304, units 306, and data unit 308. The units 306 and the memory 304 may be coupled to the processor 302.

The processor 302 may be a single processing unit or several processing units, all of which could include multiple computing units. The processor 302 may be implemented as at least one processor, one or more microprocessors, microcomputers, microcontrollers, digital signal processors, central processing units, state machines, logic circuitries, and/or any electronic devices that manipulate signals based on operational instructions. Among other capabilities, the processor 302 is configured to access and execute computer-readable instructions and data stored in the memory 304.

The processor 302 may control all functions of the electronic device 300. The processor 302 may perform the method 200 by executing instructions stored in the memory 304. The processor 302 may control the units 306 by using instructions stored in the memory 304 and/or data stored in the data unit 308. The processor 302 may perform the method 200 by controlling the units 306 by using instructions stored in the memory 304 and/or data stored in the data unit 308.

For example, the processor 302 may be configured to convert the position coordinates of the first device in the first coordinate system into position coordinates of the first device in a global coordinate system, convert the position coordinates of the first device in the global coordinate system into position coordinates of the first device in a user coordinate system.

The memory 304 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 304 may store the instructions executing the method 200. The instructions stored in the memory 304 may be read or write by the processor 302.

The units 306 may include, amongst other things, routines, programs, objects, components, data structures, etc., which perform particular tasks or implement data types. The units 306 may also be implemented as, signal processor(s), state machine(s), logic circuitries, and/or any other electronic device or component that manipulate signals based on operational instructions.

The units 306 may be implemented in hardware, instructions executed by a processing unit, or by a combination thereof. The processing unit may comprise a computer, a processor, such as the processor 302, a state machine, a logic array, or any other suitable IoT device capable of processing instructions. The processing unit may be a general-purpose processor which executes instructions to cause the general-purpose processor to perform the required tasks or, the processing unit may be dedicated to performing the required functions. In an embodiment of the present disclosure, the units 306 may be machine-readable instructions (software) which, when executed by a processor/processing unit, perform any of the described functionalities.

In an embodiment, the units 306 may include a detecting unit 310, a converting unit 312, a transceiver 314, a position sensor 316, an accelerometer 318. In an embodiment, the detecting unit 310 may include a UWB chip 310a. In an embodiment, the converting unit 312 may include a global coordinate transformation engine 320 and linear transformation engine 322. In an embodiment, the transceiver 314 may include a Bluetooth low-energy (BLE) chip 314a.

The various units 310, 312, 314, 316, 318, 320, and 322 may be in communication with each other. In an embodiment, the various units 310, 312, 314, 316, 318, 320, and 322 may be a part of the processor 302. In an embodiment, the processor 302 may be configured to perform functions of the units 310, 312, 314, 316, 318, 320, and 322. The data unit 308 may serve, amongst other things, as a repository for storing data processed, received, and generated by one or more of the units 306. The data unit 308 may serve, amongst other things, as a repository for storing data processed, received, and generated by the units 306 controlled by the processor 302. The units 305 may referred to as components that may perform a function of the electronic device 300. For example, the function may include a function corresponding to the function of the detection unit 310, or a function corresponding to the function of the accelerometer 318.

The electronic device 300 may be referred to as a third device or a system. The electronic device 300 may be a part of the third device. The electronic device 300 may be correspond to the third device or the system. In an embodiment, the electronic device 300 may be the mobile device 101, shown in FIG. 1.

Referring to FIG. 2, as shown in FIG. 2, at operation 201, the method 200 may comprise detecting, by the electronic device 300 using an Ultra-WideBand (UWB) tag (or an UWB chip) 310a, position coordinates of the first device 401 with respect to a position of the electronic device 300.

As shown in FIG. 4, an environment 400 may include a first device 401, which may be a smart tag (or a UWB tag), whose position is to be displayed on a second device 403, which may be a smart watch. For example, the position of the first device 401 may be displayed on a display screen 914 of the second device 403. The environment 400 may also include the electronic device 300, which may be a mobile phone. Accordingly, the electronic device 300 may be a part of the mobile phone or may be correspond to the mobile phone. In an embodiment, the electronic device 300 may be connected to the mobile phone. The mobile phone may be referred to as a mobile device.

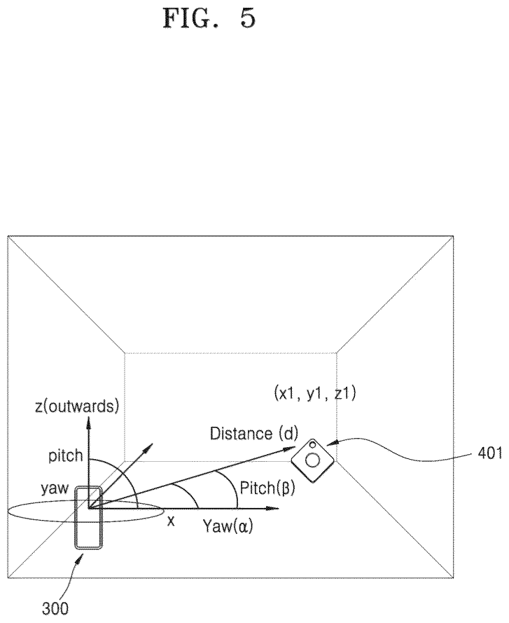

The detecting unit 310 may detect the position coordinates (x1, y1, z1) of the first device 401 using the UWB chip 310a. The position coordinates (x1, y1, z1) of the first device 401 may correspond to the position of the first device 401 in a first coordinate system. In an embodiment, the first coordinate system may define the position of the first device 401 with respect to a UWB sensor plane of the electronic device 300, as shown in FIG. 5.

FIG. 5 illustrates determination of position coordinates (x1, y1, z1) of the first device 401 in the first coordinate system, in accordance with an embodiment of the present disclosure. The electronic device 300 (i.e., mobile phone) performs ranging (using the UWB chip 310a) with the first device 401 (or an Anchor) to get a yaw angle (a) and a pitch angle (B). The yaw angle (a) is the angle of rotation around the z-axis. The pitch angle (B) is the angle of rotation around the y-axis. The distance “d” between the electronic device 300 and the first device 401 is determined using the yaw angle (a) and the pitch angle (B). Accordingly, the electronic device 300 may determine the position coordinates (x1, y1, z1) of the first device 401 (or the position coordinates of the first device 401 in the first coordinate system) based on the yaw angle (a), the pitch angle (B), and the distance “d” between the electronic device 300 and the first device (UWB chip or UWB sensor) 401, using below equation 2 (or matrix):

$${Matrix}_{coordinates in Current Orientation} = [ \begin{matrix}d cos ( β ) cos ( α ) \\ d cos ( β ) sin ( α ) \\ d sin ( β )\end{matrix} ] = [ \begin{matrix}x 1 \\ y 1 \\ z 1\end{matrix} ] \qquad ( 2 )$$

In equation 2, Matrix_{coordinates in Current Orientation} in equation 2 may be defined as coordinates (or position coordinates) of the position sensor 316 with respect to the electronic device 300 in current orientation, x1, y1, z1 are coordinates (or position coordinates) of the first device 401. This coordinates system has an origin at the electronic device 300 and is aligned with the UWB sensor plane of the electronic device 300.

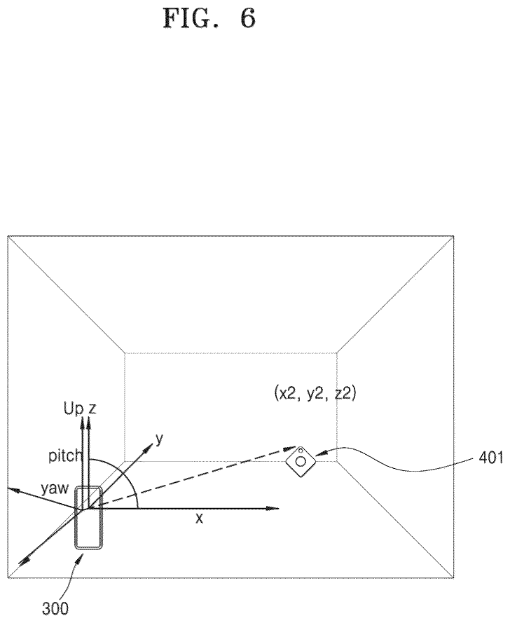

Referring back to FIG. 2, at step 203, the method 200 may comprise converting, by the electronic device 300, the position coordinates of the first device 401 (or the position coordinates of the first device 401 in the first coordinate system) into position coordinates (x2, y2, z2) in a global coordinate system. In an embodiment, the converting unit 312 may convert the position coordinates (x1, y1, z1) of the first device 401 in the first coordinate system into the position coordinates (x2, y2, z2) of the first device 401 in the global coordinate system, as described in FIG. 6.

FIG. 6 illustrates conversion of the position coordinates (x1, y1, z1) of the first device 401 in the first coordinate system to the position coordinates (x2, y2, z2) in the global coordinate system using the position sensor 316, in accordance with an embodiment of the present disclosure.

As shown in FIG. 6, the position coordinates (x1, y1, z1) in the first coordinate system are transformed into the position coordinates (x2, y2, z2) in the global coordinate system with respect to the electronic device 300 as origin. The electronic device 300 is considered as an origin of a local tangent plane. In an embodiment, the global coordinate transformation engine 320 may convert the position coordinates (x1, y1, z1) in the first coordinate system into the position coordinates (x2, y2, z2) in the global coordinate system. In an embodiment, the global coordinate transformation engine 320 may use a rotation matrix obtained via the position sensor 316 to convert the position coordinates (x1, y1, z1) in the first coordinate system into the position coordinates (x2, y2, z2) in the global coordinate system. In an embodiment, the global coordinate transformation engine 320 may use equation 3 below to covert the position coordinates (x1, y1, z1) in the first coordinate system into the position coordinates (x2, y2, z2) in the global coordinate system:

$${Matrix}_{coordinates after Sensor correction} = {R}_{rotation Matrix} \cdot {Matrix}_{Global Coordinates or Local tangent Plane} \qquad ( 3 )$$

$$\begin{matrix}{Matrix}_{coordinates in Current Orientation} = {R}_{magnetic rotation Matrix} \cdot \\ {Matrix}_{coordinates after Sensor correction} \\ = {R}_{sensor rotation Matrix} \cdot ( {R}_{sensor rotation Matrix} \cdot \\ {Matrix}_{Local plane coordinates} )\end{matrix}$$

In equation 3, Matrix_{coordinates in current orientation} is known from equation 2, Matrix_{coordinates after Sensor correction} may be referred to as coordinates of the first device 401 with respect to coordinate system of the position sensor 316. The position sensor 316 may define its own x, y, z axis based on which it calculates direction from North. Matrix_{coordinates after Sensor correction} refers to a general way of transformation of coordinate conversion from the global coordinate system to the position sensor 316 reference frame (or the user coordinate system) after multiplication with a rotation matrix from the position sensor (or a magnetic sensor) 316. Matrix_{Global Coordinates or Local tangent Plane} may be referred to as coordinates of an object (a user 407) with an origin at the electronic device 300 (i.e., a mobile device) but coordinate system has x-axis aligned with East, y-axis aligned with North and z-axis UP (away from earth). R_{rotation Matrix} is the rotation matrix which translates Global Coordinates into a sensor plane coordinate system. So, Matrix_{Global coordinates} may be obtained from following equation (4):

$${Matrix}_{Global coordinates} = {R}_{position rotation matrix}^{- 1} \cdot ( {R}_{sensor rotation matrix}^{- 1} \cdot {Matrix}_{coordinates in Current Orientation} ) \qquad ( 4 )$$

In equation 4, R⁻¹_{rotation matrix} is the inverse rotation matrix which translates Global Coordinates into a sensor plane coordinate system, and R⁻¹_{sensor rotation matrix} is the inverse rotation required to transform the matrix to a current view/screen as the position sensor 316 may not be aligned with a screen orientation, like for fold or other phones. This matrix is considered as Unity in the present disclosure as the mobile device according to an embodiment has a screen and sensors (UWB and Magnetic) oriented in same direction.

Since Sensor Rotation Matrix is unity, an inverse is also a unity Matrix, so

$${Matrix}_{Global coordinates} = {R}_{position rotation matrix}^{- 1} \cdot {Matrix}_{coordinates in Current Orientation} ) \qquad ( 5 )$$

Hence, the global coordinate transformation engine 320 may obtain position coordinates (x2, y2, z2) in the global coordinates system using equation 3. The global coordinate system may define the position coordinates considering the electronic device 300 as an origin point of the position coordinates of the first device 401. The position sensor 316 may be any known sensor used to obtain the rotation matrix R_{magnetic rotation matrix} in equation 3, such as a magnetic sensor.

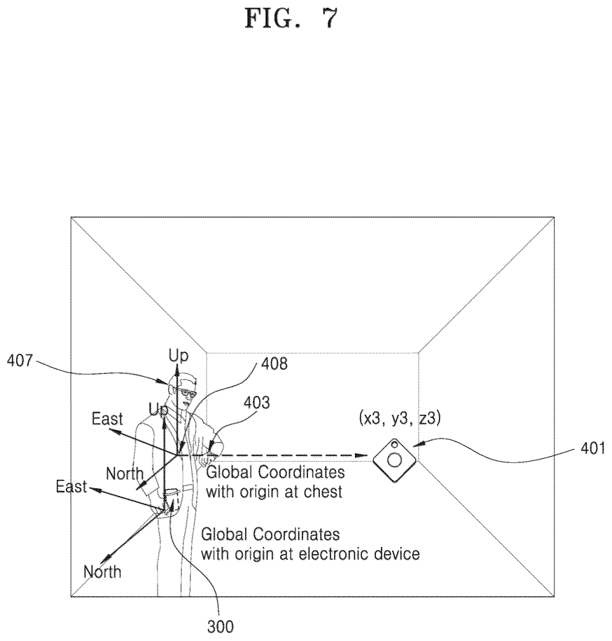

Referring back to FIG. 2, at step 205, the method 200 may comprise converting, by the electronic device 300, the position coordinates (x2, y2, z2) in the global coordinate system into position coordinates in a user coordinate system. In an embodiment, the user coordinate system may define the position coordinates considering a user of the electronic device 300 as an origin point of the position coordinates of the first device 401. In an embodiment, the converting unit 312 may convert the position coordinates (x2, y2, z2) of the first device 401 in the global coordinate system into the position coordinates of the first device 401 in the user coordinate system, as described in FIG. 7.

FIG. 7 illustrates conversion of position coordinates (x2, y2, z2) of the first device 401 in the global coordinate system to the position coordinates (x3, y3, z3) of the first device 401 in the user coordinate system, in accordance with an embodiment of the present disclosure. As shown in FIG. 7, the position coordinates (x2, y2, z2) in the global coordinate system are transformed into the position coordinates (x3, y3, z3) in the user coordinate system with respect to a user 407 of the electronic device 300 as origin. In an embodiment, the linear transformation engine 322 may convert the position coordinates (x2, y2, z2) in the global coordinate system into the position coordinates (x3, y3, z3) in the user coordinate system (x3, y3, z3). In an embodiment, the linear transformation engine 322 may determine height and gait of the user 407 (where “gait”, as used herein, refers to an average pace or step length of the user), using the position sensor 316. In an embodiment, the linear transformation engine 322 may determine a gait of the user 407 using the accelerometer 318 and may obtain information related to a height of the user 407 from the user 407. For example, the information related to the height of the user 407 may be input by the user 407. For example, the information related to the height of the user 407 may be estimated based on an image including the user 407 stored in the electronic device 300. For example, the information related to the height of the user 407 may be detected from user information stored in the electronic device 300. Then, the linear transformation engine 322 may determine the position and a direction of the electronic device 300 based on the information related to the height and gait of the user 407. Then, the linear transformation engine 322 may convert the position coordinates (x2, y2, z2) of the first device 401 in the global coordinate system into the position coordinates (x3, y3, z3) of the first device 401 in the user coordinate system based on the information related to the height and gait of the user 407. In an embodiment, the linear transformation engine 322 may perform a linear transformation on the position coordinates (x2, y2, z2) of the first device 401 in the global coordinate system to get the position coordinates (x3, y3, z3) of the first device 401 in the user coordinate system, with origin at user's chest 408 Referring back to FIG. 2, at step 207, the method 200 may comprise transmitting, by the electronic device 300, the converted position coordinates (x3, y3, z3) in the user coordinate system to the second device 403. In an embodiment, the transceiver 314 may transmit the converted position coordinates (x3, y3, z3) in the user coordinate system to the second device 403 using the BLE chip 314a. Upon receiving the converted position coordinates (x3, y3, z3), the second device 403 may re-convert the converted position coordinates (x3, y3, z3) in the user coordinate system into position coordinates in a second coordinate system to obtain the position of the first device 401 and may control a display screen 914 to display the obtained position coordinates of the first device 401. This process has been described in detail with respect to FIGS. 4 and 8-11.

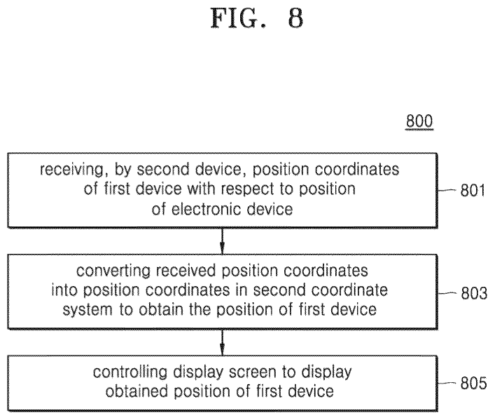

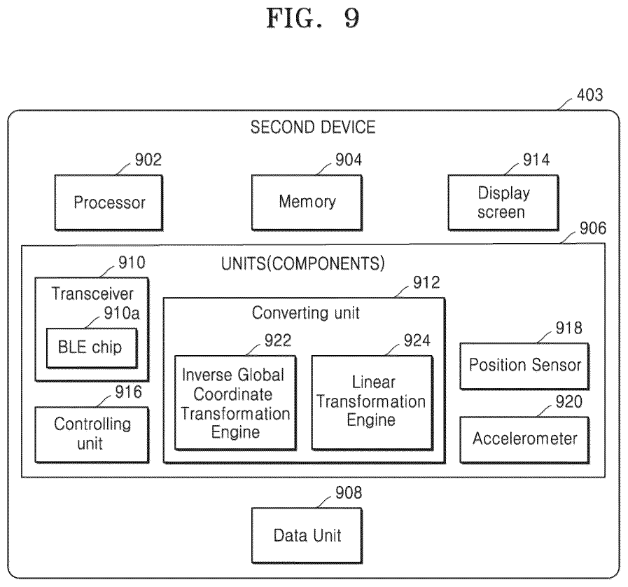

FIG. 8 illustrates a flow diagram depicting a method 800 for displaying a position of the first device 401 on the second device 403, in accordance with an embodiment of the present disclosure. FIG. 9 illustrates a block diagram of the second device 403 for displaying the position of the first device 401 on the second device 403, in accordance with an embodiment of the present disclosure. For the sake of brevity, the description of FIGS. 8 and 9 are explained in conjunction with each other.

Referring to FIG. 9, the second device 403 may include, but is not limited to, a processor 902, memory 904, units (or components) 906, and data unit 908. The units 906 and the memory 904 may be coupled to the processor 902.

The processor 902 may be a single processing unit or several processing units, all of which could include multiple computing units. The processor 902 may be implemented as at least one processor, one or more microprocessors, microcomputers, microcontrollers, digital signal processors, central processing units, state machines, logic circuitries, and/or any electronic devices that manipulate signals based on operational instructions. Among other capabilities, the processor 902 is configured to fetch and execute computer-readable instructions and data stored in the memory 904. The processor 902 may perform an operation based on the flow diagram shown in FIG. 8 by executing the instructions and data stored in the memory 904.

The memory 904 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The units 906 amongst other things, may include routines, programs, objects, components, data structures, etc., which perform particular tasks or implement data types. The units 906 may also be implemented as, signal processor(s), state machine(s), logic circuitries, and/or any other electronic device or component that manipulate signals based on operational instructions. The units 906 may be referred to as components that may perform a function of the second device 403. For example, the function may include a function corresponding to the function of the converting unit 912 or a function corresponding to the function of the accelerometer 920.

The units 906 may be implemented in hardware, instructions executed by a processing unit, or by a combination thereof. The processing unit may comprise a computer, at least one processor, such as the processor 902, a state machine, a logic array, or any other suitable device capable of processing instructions. The processing unit may be a general-purpose processor which executes instructions to cause the general-purpose processor to perform the required tasks or, the processing unit may be dedicated to performing the required functions. In an embodiment of the present disclosure, the units 906 may be machine-readable instructions (software) which, when executed by a processor/processing unit, perform any of the described functionalities.

In an embodiment, the units 906 may include a transceiver 910, a converting unit 912, a display screen 914, a controlling unit 916, a position sensor 918, an accelerometer 920. In an embodiment, the converting unit 912 may include an inverse global coordinate transformation engine 922 and a linear transformation engine 924. In an embodiment, the transceiver 910 may include a Bluetooth low-energy (BLE) chip 912a.

The various units 910, 912, 916, 918, 920, 922, and 924 may be in communication with each other. In an embodiment, the various units 910, 912, 916, 918, 920, 922, and 924 may be a part of the processor 902. In an embodiment, the processor 902 may be configured to perform the functions of units 910, 912, 916, 918, 920, 922, and 924. The data unit 908 serves, amongst other things, as a repository for storing data processed, received, and generated by one or more of the units 906. The second device 403 may be a part of an electronic device, such as a smart watch. The second device 403 may be correspond to the smart watch. In an embodiment, the second device 403 may be connected to the smart watch. The second device may be referred to as a system, an electronic device, or the smart watch.

Referring back to FIG. 8, at step 801, the method 800 may comprise receiving, by the second device 403, position coordinates of the first device 401 with respect to a position of the electronic device 300, wherein the position coordinates of the first device 401 correspond to the position coordinates (x3, y3, z3) in the user coordinate system. With respect to FIG. 4, the second device 403 may be a part of the second device 403, such as the smart watch. In an embodiment, the electronic device 300 may be connected to the second device (or smart watch) 403. Accordingly, the transceiver 910 may receive the converted position coordinates (x3, y3, z3) in the user coordinate system using the BLE chip 910a.

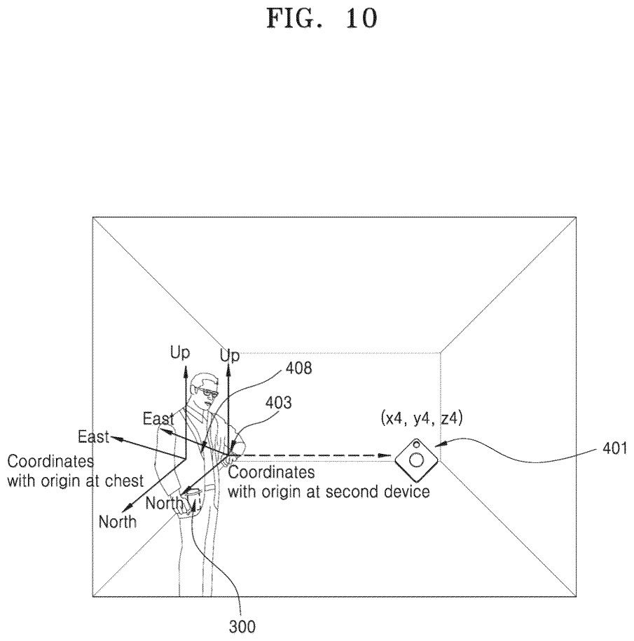

Then, at step 803, the method 800 may comprise converting the received position coordinates of the first device 401 into position coordinates of the first device 401 in the second coordinate system to obtain the position of the first device 401. In an embodiment, the converting unit 912 may determine position of the second device 403 with respect to the user 407 of the second device 403. In an embodiment, the converting unit 912 may determine the position of the second device 403 with respect to the user 407 using the accelerometer 920. Then, the converting unit 912 may perform linear transformation to convert the received position coordinates of the first device 401 into position coordinates (x4, y4, z4) of the first device 401 in an intermediary coordinate system with respect to the position of the second device 403, as shown in FIG. 10.

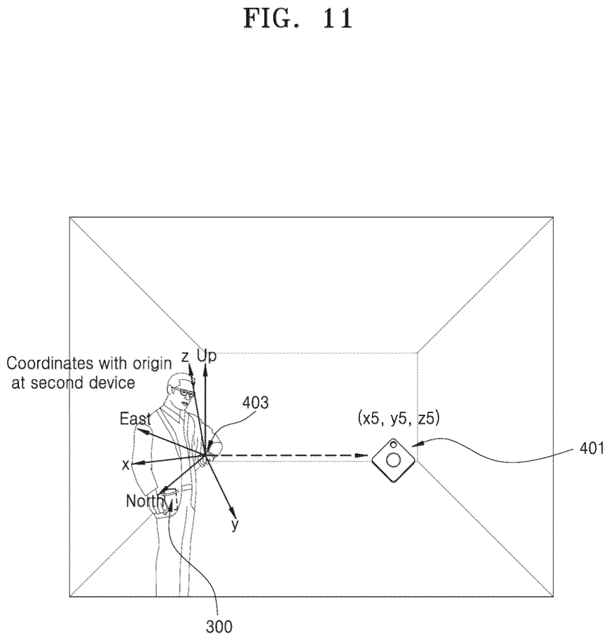

FIG. 10 illustrates linear transformation of position coordinates of the first device 401 in the user coordinate system into the position coordinates (x4, y4, z4) of the first device 401 in the intermediate coordinate system using linear transformation engine 924, in accordance with an embodiment of the present disclosure. In an embodiment, the linear transformation engine 924 may transform the position coordinates of the first device 401 in the user coordinate system into the position coordinates (x4, y4, z4) of the first device 401 in the intermediate coordinate system using the accelerometer 920. The linear transformation engine 924 may perform the liner transformation to transform the position coordinates in the user coordinate system into the position coordinates (x4, y4, z4) in the intermediate coordinate system. Then, the inverse global coordinate transformation engine 922 may convert the position coordinates the position coordinates (x4, y4, z4) in the intermediary coordinate system into the position coordinates in the second coordinate system with respect to local plane of the second device 403, to obtain the position of the first device 401 with respect to position of the second device 403, as shown in FIG. 11.

FIG. 11 illustrates conversion of position coordinates (x4, y4, z4) of the first device 401 in the intermediary coordinate system into the position coordinates (x5, y5, z5) of the first device 401 in the second coordinate system, in accordance with an embodiment of the present disclosure. As shown in FIG. 11, the inverse global coordinate transformation engine 922 may determine an inverse Transformation Matrix using a rotation matrix obtained from the position sensor 918, such as a magnetic sensor. Then, the inverse global coordinate transformation engine 922 may transform the position coordinate (x4, y4, z4) in the intermediate coordinate system into the position coordinates (x5, y5, z5) in the second coordinate system using matrix multiplication. In an embodiment, the inverse global coordinate transformation engine 922 may obtain the position of the first device 401 using below equation 6:

$${Matrix}_{coordinates in local plane} = {R}_{Rotation Matrix}^{- 1} \cdot {Matrix}_{Global coordinates} \qquad ( 6 )$$

In equation 6, R⁻¹_{Rotation Matrix} is the inverse of the Rotation matrix of the second device 403 (i.e., a smart watch), Matrix_{coordinates in local plane} is the coordinates in the plane of the display screen 914 of the second device 403, Matrix_{Global Coordinates} is the coordinate system aligned with East North and UP, and R_{Rotation Matrix} (this is different from that used in earlier equations) is the rotation matrix which provides a direction of North with respect to a watch coordinate system. This matrix translates watch coordinates into global coordinates, hence we take the inverse. The rotation matrix may be obtained in a similar manner as described with respect to FIG. 7.

Referring back to FIG. 8, at step 805, the method 800 may comprise controlling the display screen 914 of the second device 403 to display the obtained position coordinates of the first device. In particular, the controlling unit 916 may control the display screen 914 to display the obtained position coordinates (x5, y5, z5) of the first device 401.

Hence, the present disclosure allows to display an accurate position of the first device 401 with a UWB tag on the second device 403 without a UWB tag.

In this disclosure, a method 200 for displaying a position of a first device 401 on a second device 403 comprises detecting, by an electronic device 300 using an Ultra-WideBand (UWB) tag, position coordinates of the first device 401 with respect to a position of the electronic device 300, wherein the position coordinates of the first device 401 correspond to position coordinates in a first coordinate system, converting, by the electronic device 300, the position coordinates of the first device 401 in the first coordinate system into position coordinates of the first device 401 in a global coordinate system, converting, by the electronic device 300, the position coordinates of the first device 401 in the global coordinate system into position coordinates of the first device 401 in a user coordinate system, and transmitting, by the electronic device 300, the converted position coordinates of the first device 401 in the user coordinate system to the second device 403 to display the position of the first device 401 on the second device 403.

In this disclosure, wherein the converted position coordinates of the first device 401 is transmitted to the second device 403 so that the second device 403 re-converts the converted position coordinates of the first device 401 in the user coordinate system into position coordinates of the first device 401 in a second coordinate system to obtain the position of the first device 401, and controls a display screen 914 of the second device 403 to display the obtained position of the first device 401.

In this disclosure, the first coordinate system defines the position of the first device 401 with respect to a UWB sensor plane of the electronic device 300, the user coordinate system defines the position coordinates considering a user 407 of the electronic device 300 as an origin point of the position coordinates of the first device 401, and the global coordinate system defines the position coordinates considering the electronic device 300 as an origin point of the position coordinates of the first device 401.

In this disclosure, the converting the position coordinates of the first device 401 in the global coordinate system into the position coordinates of the first device 401 in the user coordinate system comprises determining a height and a gait of the user 407, using a position sensor 316 included in the electronic device 300, determining the position and a direction of the electronic device 300 based on the height and the gait, and converting the position coordinates of the first device 401 in the global coordinate system into the position coordinates of the first device 401 in the user coordinate system based on the height and the gait of the user.

In this disclosure, the first device 401 comprises a UWB tag.

In this disclosure, the second device 403 does not comprise a UWB tag.

In this disclosure, the converting the position coordinates of the first device 401 in the first coordinate system into the position coordinates of the first device 401 in the global coordinate system comprises converting the position coordinates of the first device 401 via a rotation matrix obtained using the position sensor 316.

In this disclosure, a method for displaying a position of a first device 401 on a second device 403 comprises receiving, by the second device 403, position coordinates of the first device 401 with respect to a position of an electronic device 300, wherein the position coordinates of the first device 401 correspond to the position coordinates of the first device 401 in a user coordinate system, converting the received position coordinates of the first device 401 in the user coordinate system into position coordinates of the first device 401 in a second coordinate system to obtain the position of the first device 401, and controlling a display screen to display the obtained position of the first device 401.

In this disclosure, the converting the received position coordinates of the first device 401 in the user coordinate system into the position coordinates of the first device 401 in the second coordinate system comprises determining a position of the second device 403 with respect to a user 407 of the second device 403, performing a linear transformation to convert the position coordinates of the first device 401 in the user coordinate system into position coordinates of the first device 401 in an intermediary coordinate system with respect to the position of the second device 403, and converting the position coordinates of the first device 401 in the intermediary coordinate system into the position coordinates of the first device 401 in the second coordinate system with respect to a local plane of the second device 403 to obtain the position of the first device 401 with respect to a position of the second device 403.

In this disclosure, the converting the position coordinates of the first device 401 in the intermediary coordinate system into the position coordinates of the first device 401 in the second coordinate system comprises converting the position coordinates of the first device 401 using a rotation matrix obtained from a position sensor 918 included in the second device 403.

In this disclosure, the electronic device 300 comprises a detecting unit 310 configured to detect, using a UWB chip 310a, position coordinates of the first device 401 with respect to a position of the electronic device 300, wherein the position coordinates of the first device 401 correspond to position coordinates of the first device 401 in a first coordinate system, a converting unit 312 configured to convert the position coordinates of the first device 401 in the first coordinate system into position coordinates of the first device 401 in a global coordinate system, and convert the position coordinates of the first device 401 in the global coordinate system into position coordinates of the first device 401 in a user coordinate system, and a transceiver 314 configured to transmit the converted position coordinates of the first device 401 in the user coordinate system to the second device 403 to display a position of the first device 401 on the second device 403.

In this disclosure, the converted position coordinates of the first device 401 is transmitted to the second device 403 so that the second device 403 re-converts the converted position coordinates of the first device 401 in the user coordinate system into position coordinates of the first device 401 in a second coordinate system to obtain the position of the first device 401, and controls a display screen 914 to display the obtained position of the first device 401.

In this disclosure, the first coordinate system defines the position of the first device 401 in respect to the UWB sensor plane of the electronic device 300.

In this disclosure, the user coordinate system defines the position coordinates considering a user 407 of the electronic device 300 as an origin point of the position coordinates of the first device 401.

In this disclosure, the global coordinate system defines the position coordinates considering the electronic device 300 as an origin point of the position coordinates of the first device 401.

In this disclosure, for converting the position coordinates of the first device 401 in the global coordinate system into the position coordinates of the first device 401 in the user coordinate system, the converting unit 312 is configured to determine a height and a gait of the user 407, using a position sensor 316 included in the electronic device 300, determine the position and a direction of the electronic device 300 based on the height and the gait, and convert the position coordinates of the first device 401 in the global coordinate system into position coordinates of the first device 401 in the user coordinate system based on the height and the gait of the user 407.

In this disclosure, the converting unit 312 is configured to convert the position coordinates of the first device 401 in the first coordinate system into the position coordinates of the first device 401 in the global coordinate system via a rotation matrix obtained using the position sensor 316.

In this disclosure, a second device 403 comprises a transceiver 910 configured to receive position coordinates of the first device 401 with respect to a position of an electronic device, wherein the position coordinates of the first device 401 correspond to the position coordinates in a user coordinate system, a converting unit 912 configured to convert the received position coordinates of the first device 401 into position coordinates of the first device 401 in a second coordinate system to obtain the position of the first device 401, and a controlling unit 916 configured to control a display screen 914 to display the obtained position of the first device 401.

In this disclosure, for converting the received position coordinates of the first device 401 into the position coordinates of the first device 401 in the second coordinate system, the converting unit 912 is configured to determine a position of the second device 403 with respect to a user 407 of the second device 403, perform a linear transformation to convert the received position coordinates of the first device 401 into position coordinates of the first device 401 in an intermediary coordinate system with respect to the position of the second device 403, and convert the position coordinates of the first device 401 in the intermediary coordinate system into position coordinates of the first device 401 in the second coordinate system with respect to local plane of the second device 403 to obtain the position of the first device 401 with respect to position of the second device 403.

In this disclosure, the converting unit 912 converts the position coordinates of the first device 401 in the intermediary coordinate system into the position coordinates of the first device 401 in the second coordinate system using a rotation matrix obtained from a position sensor.

In this disclosure, the electronic device 300 comprises a detecting unit 310 configured to detect, using a UWB chip 310a, position coordinates of the first device 401 with respect to a position of the electronic device 300, wherein the position coordinates of the first device 401 correspond to position coordinates of the first device 401 in a first coordinate system, at least one processor 302 configured to convert the position coordinates of the first device 401 in the first coordinate system into position coordinates of the first device 401 in a global coordinate system, and convert the position coordinates of the first device 401 in the global coordinate system into position coordinates of the first device 401 in a user coordinate system, and a transceiver 314 configured to transmit the converted position coordinates of the first device 401 in the user coordinate system to the second device 403 to display a position of the first device 401 on the second device 403.

In this disclosure, for converting the position coordinates of the first device 401 in the global coordinate system into the position coordinates of the first device 401 in the user coordinate system, the at least one processor 302 is configured to determine a height and a gait of the user 407, using a position sensor 316 included in the electronic device 300, determine the position and direction of the electronic device 300 based on the height and the gait, and convert the position coordinates of the first device 401 in the global coordinate system into position coordinates of the first device 401 in the user coordinate system based on the height and gait of the user 407.

In this disclosure, the at least one processor 302 is configured to convert the position coordinates of the first device 401 in the first coordinate system into the position coordinates of the first device 401 in the global coordinate system via a rotation matrix obtained using the position sensor 316.

In an embodiment, a computer readable medium contains instructions that, when executed, cause at least one processor 302 to display a position of a first device 401 on a second device 403. The computer readable medium also contains instructions that, when executed, cause the at least one processor 302 to detect, by an electronic device 300 using an Ultra-WideBand (UWB) tag, position coordinates of the first device 401 with respect to a position of the electronic device 300, wherein the position coordinates of the first device 401 correspond to position coordinates of the first device 401 in a first coordinate system, convert, by the electronic device 300, the position coordinates of the first device 401 in the first coordinate system into position coordinates of the first device 401 in a global coordinate system, convert, by the electronic device 300, the position coordinates of the first device 401 in the global coordinate system into position coordinates of the first device 401 in a user coordinate system, and transmit, by the electronic device 300, the converted position coordinates of the first device 401 in the user coordinate system to the second device 403 to display the position of the first device 401 on the second device 403. While specific language has been used to describe the disclosure, any limitations arising on account of the same are not intended. As would be apparent to a person in the art, various working modifications may be made to the method in order to implement the disclosure. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for displaying a position of a first device on a second device, the method comprising:
detecting, by an electronic device using an ultra-wide band (UWB) chip, position coordinates of the first device with respect to a position of the electronic device, wherein the position coordinates of the first device correspond to position coordinates in a first coordinate system;
converting, by the electronic device, the position coordinates of the first device in the first coordinate system into position coordinates of the first device in a global coordinate system;
converting, by the electronic device, the position coordinates of the first device in the global coordinate system into position coordinates of the first device in a user coordinate system;
transmitting, by the electronic device, the converted position coordinates of the first device in the user coordinate system to the second device; and
displaying the position of the first device on the second device based on the converted position coordinates of the first device in the user coordinate system.

2. The method of claim 1, wherein the displaying the position of the first device on the second device comprises:
re-converting, by the second device, the converted position coordinates of the first device in the user coordinate system into position coordinates of the first device in a second coordinate system;
obtaining the position of the first device based on the position coordinates of the first device in the second coordinate system; and
controlling a display screen of the second device to display the obtained position of the first device.

3. The method of claim 1,
wherein the position of the first device is defined with respect to a UWB sensor plane of the electronic device in the first coordinate system,
wherein a user of the electronic device is defined as an origin point of the position coordinates of the first device in the user coordinate system, and
wherein the electronic device is defined as an origin point of the position coordinates of the first device in the global coordinate system.

4. The method of claim 3, wherein the converting the position coordinates of the first device in the global coordinate system into the position coordinates of the first device in the user coordinate system comprises:
determining a height and a gait of the user using a position sensor of the electronic device;
determining the position and a direction of the electronic device based on the height and the gait of the user; and
converting the position coordinates of the first device in the global coordinate system into the position coordinates of the first device in the user coordinate system based on the height and the gait of the user.

5. The method of claim 1, wherein the first device comprises a UWB tag.

6. The method of claim 1, wherein the second device does not comprise a UWB chip.

7. The method of claim 4, wherein the converting the position coordinates of the first device in the first coordinate system into the position coordinates of the first device in the global coordinate system comprises converting the position coordinates of the first device via a rotation matrix obtained using the position sensor.

8. An electronic device comprising:
a transceiver;
an ultra-wide band (UWB) chip configured to detect UWB devices within a distance of the UWB chip;
memory storing one or more instructions; and
at least one processor configured to execute the one or more instructions,
wherein the one or more instructions, when executed by the at least one processor, cause the electronic device to:
detect, using the UWB chip, position coordinates of a first device with respect to a position of the electronic device, wherein the position coordinates of the first device correspond to position coordinates in a first coordinate system,
convert the position coordinates of the first device into position coordinates of the first device in a global coordinate system,
convert the position coordinates of the first device in the global coordinate system into position coordinates of the first device in a user coordinate system,
transmit, to a second device through the transceiver, the converted position coordinates of the first device in the user coordinate system, and
control the second device to display a position of the first device based on the converted position coordinates of the first device in the user coordinate system.

9. The electronic device of claim 8, wherein the one or more instructions, when executed by the at least one processor, cause the electronic device to:
control the second device to re-convert the converted position coordinates of the first device in the user coordinate system into position coordinates of the first device in a second coordinate system,
to obtain the position of the first device based on the position coordinates of the first device in the second coordinate system, and
control the second device to display, on a display screen of the second device, the obtained position of the first device.

10. The electronic device of claim 8,
wherein the position of the first device is defined with respect to a UWB sensor plane of the electronic device in the first coordinate system,
wherein a user of the electronic device is defined as an origin point of the position coordinates of the first device in the user coordinate system, and
wherein the electronic device is defined as an origin point of the position coordinates of the first device in the global coordinate system.

11. The electronic device of claim 10, further comprising:
a position sensor,
wherein the one or more instructions, when executed by the at least one processor, cause the electronic device to convert the position coordinates of the first device in the global coordinate system into the position coordinates of the first device in the user coordinate system by:
determining a height and a gait of the user, using the position sensor,
determining the position and a direction of the electronic device based on the height and the gait of the user; and
converting the position coordinates of the first device in the global coordinate system into the position coordinates of the first device in the user coordinate system based on the height and the gait of the user.

12. The electronic device of claim 11, wherein the one or more instructions, when executed by the at least one processor, cause the electronic device to:
convert the position coordinates of the first device in the first coordinate system into the position coordinates of the first device in the global coordinate system via a rotation matrix obtained using the position sensor.

13. A non-transitory computer readable medium having instructions stored therein, which when executed by at least one processor cause the at least one processor to execute a method for displaying a position of a first device on a second device, the method comprising:
detecting, by an electronic device using an ultra-wide band (UWB) tag, position coordinates of the first device with respect to a position of the electronic device, wherein the position coordinates of the first device correspond to position coordinates in a first coordinate system;
converting, by the electronic device, the position coordinates of the first device in the first coordinate system into position coordinates of the first device in a global coordinate system;
converting, by the electronic device, the position coordinates of the first device in the global coordinate system into position coordinates of the first device in a user coordinate system;
transmitting, by the electronic device, the converted position coordinates of the first device in the user coordinate system to the second device; and
displaying the position of the first device on the second device based on the converted position coordinates of the first device in the user coordinate system.

14. The non-transitory computer readable medium of claim 13, wherein the displaying the position of the first device on the second device comprises:
re-converting, by the second device, the converted position coordinates of the first device in the user coordinate system into position coordinates of the first device in a second coordinate system;
obtaining the position of the first device based on the position coordinates of the first device in the second coordinate system; and
controlling a display screen of the second device to display the obtained position of the first device.

15. The non-transitory computer readable medium of claim 13,
wherein the position of the first device is defined with respect to a UWB sensor plane of the electronic device in the first coordinate system,
wherein a user of the electronic device is defined as an origin point of the position coordinates of the first device in the user coordinate system, and
wherein the electronic device is defined as an origin point of the position coordinates of the first device in the global coordinate system.

16. The non-transitory computer readable medium of claim 15, wherein the converting the position coordinates of the first device in the global coordinate system into the position coordinates of the first device in the user coordinate system comprises:
determining a height and a gait of the user using a position sensor of the electronic device;
determining the position and a direction of the electronic device based on the height and the gait of the user; and
converting the position coordinates of the first device in the global coordinate system into the position coordinates of the first device in the user coordinate system based on the height and the gait of the user.

17. The non-transitory computer readable medium of claim 13, wherein the first device comprises a UWB tag.

18. The non-transitory computer readable medium of claim 13, wherein the second device does not comprise a UWB chip.

19. The non-transitory computer readable medium of claim 16, wherein the converting the position coordinates of the first device in the first coordinate system into the position coordinates of the first device in the global coordinate system comprises converting the position coordinates of the first device via a rotation matrix obtained using the position sensor.
